(19) United States
(12) Patent Application Publication
(10) Pub. No.: US 2011/0310887 A1
(43) Pub. Date: Dec. 22, 2011

(54) CABLE MODEM AND METHOD OF SUPPORTING VARIOUS PACKET CABLE PROTOCOLS

(75) Inventors: LU-MENG HSU, Tu-Cheng (TW); JUN-REN HUANG, Tu-Cheng (TW); YEW-MIN LO, Tu-Cheng (TW)

(73) Assignee: HON HAI PRECISION INDUSTRY CO., LTD., Tu-Cheng (TW)

(21) Appl. No.: 12/862,778

(22) Filed: Aug. 25, 2010

(30) Foreign Application Priority Data
Jun. 17, 2010 (CN) 201010201998.3

(51) Int. Cl. H04L 12/66

(52) U.S. Cl. 370/352; 725/111

(57) ABSTRACT

A cable modem in communication with a trivial file transfer protocol (TFTP) server includes a default system and a backup system employing various packet cable protocols. The cable modem boots with the default system, obtains a vendor specific information (VSIF) from the TFTP server, and determines if the VSIF matches with the default system. The cable modem continuously boots with the default system if the VSIF matches with the default system. The cable modem configures the currently default system to be the backup system and configures the currently backup system to be the default system, and reboots with the newly configured default system if the VSIF mismatches with the default system.

### BACKGROUND

1. Technical Field

Embodiments of the present disclosure relate to modems, and more particularly to a cable modem and a method of supporting various packet cable protocols.

2. Description of Related Art

Packet cable is an important protocol of cable modems to provide multimedia service over Internet protocol, such as voice over Internet protocol (VoIP) service. There are various packet cable protocols, such as packet cable version 1.0, packet cable version 1.5, and packet cable version 2.0.

Media gateway control protocol (MGCP) and session initiation protocol (SIP) are two important protocols for VoIP service. However, because MGCP and SIP respectively correspond to different packet cable protocols, MGCP and SIP are incompatible. In detail, MGCP corresponds to packet cable 1.0 or 1.5 and cannot correspond to packet cable 2.0. SIP corresponds to packet cable 2.0 and cannot correspond to packet cable 1.0 or 1.5.

Generally, packet cable protocol of a cable modem is either packet cable 2.0 or packet cable 1.0 or 1.5, which are determined by protocol of a communication network of the cable modem. In detail, if the communication network uses MGCP to provide VoIP service, the cable modem must use packet cable 1.0 or 1.5. If the communication network uses SIP to provide VoIP service, the cable modem must use packet cable 2.0. Therefore, when the protocol of the communication network is changed, the cable modem is required to be discarded and a new cable modem is required, which causes inconvenience and high cost.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment of one embodiment of a cable modem of the present disclosure;

FIG. 2 is a schematic diagram of functional modules of one embodiment of a cable modem of the present disclosure;

FIG. 3 is a flowchart of a method of supporting various of packet cable protocol of one embodiment of the present disclosure; and

FIG. 4 is a detail flowchart of the block 5306 of determining if the VSIF in the configuration file is configured as 1 or 2 of the method shown in FIG. 3.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

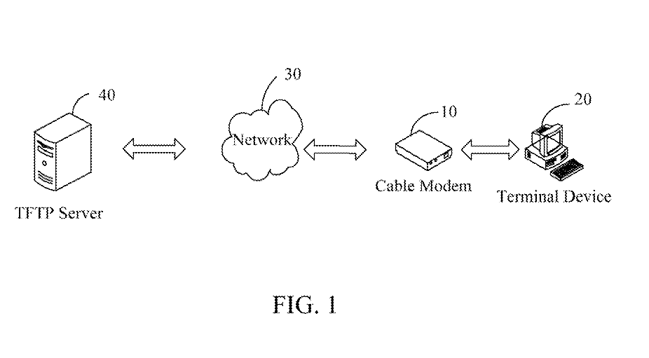

FIG. 1 is a schematic diagram of environment of one embodiment of a cable modem 10 of the present disclosure. The cable modem is operable to 10 boot and obtain a configuration file from a trivial file transfer protocol (TFTP) server 40 using a network 30. Accordingly, the cable modem 10 provides VoIP services for the terminal device 20. In one embodiment, the terminal device 20 may be a computer or an IP telephone, for example.

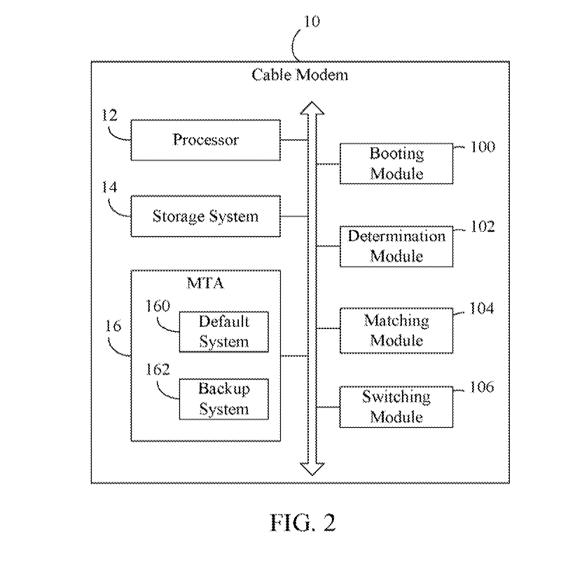

FIG. 2 is a schematic diagram of functional modules of one embodiment of a cable modem 10 of the present disclosure. In one embodiment, the cable modem 10 includes a processor 12, a storage system 14, a multimedia terminal adapter (MTA) 16, a booting module 100, a determination module 102, a matching module 104, and a switching module 106. Those modules may include one or more programs stored in the storage system 14 and executed by the processor 12.

In one embodiment, the MTA 16 provides voice over Internet protocol (VoIP) service for the terminal device 20. The MTA 16 includes a default system 160 and a backup system 162. The default system 160 and the backup system 162 indicate different MTAs that employ different packet cable (PC) protocols, such as PC1.0, PC1.5, or PC2.0. In one embodiment, the default system 160 employs PC2.0, and the backup system employs PC1.0 or PC1.5. In another embodiment, the default system 160 employs PC1.0 or PC1.5, and the backup system employs PC2.0.

In one embodiment, the booting module 100 boots with the default system 160 in the MTA 16. The determination module 102 obtains a configuration file from the TFTP server 40. Generally, the cable modem 10 requires obtaining the configuration file from the TFTP server 40 to obtain configuration configured by a service provider for the cable modem 10 while provisioning of the cable modem 10.

The determination module 102 determines if the service provider configures a vendor specific information (VSIF) in the configuration file as 1 or 2. According to data over cable service interface specifications (DOCSIS), if the VSIF is configured as 1 by the service provider, the cable modem 10 is required to work under session initiation protocol (SIP) which corresponds to PC2.0. If the VSIF is configured as 2 the by the service provider, the cable modem 10 is required to work under media gateway control protocol (MGCP) which corresponds to PC1.0 or PC 1.5. Thus, if the VSIF is configured as 1, the VSIF can match with a MTA which employs PC2.0. If the VSIF is configured as 2, the VSIF can match with a MTA which employs PC1.0 or PC1.5.

The booting module 100 continuously boots with the default system 160 until the cable modem 10 completes the provisioning, when the VSIF in the configuration file is configured as neither 1 nor 2.

The matching module 104 determines if the VSIF matches with the currently default system 160 when the VSIF in the configuration file is configured as 1 or 2. In detail, the matching module 104 determines that the VSIF mismatches with the currently default system 160 when the VSIF is configured as 1 and the default system 160 does not employ PC 2.0 or when the VSIF is configured as 2 and the default system 160 does not employ PC1.0 or PC1.5. In contrary, the matching module 104 determines that the VSIF matches with the currently default system 160 when the VSIF is configured as 1 and the default system 160 employs PC2.0 or when the VSIF is configured as 2 and the default system 160 employs PC1.0 or PC1.5.

The matching module 104 notifies the booting module 100 to continuously boot with the default system 160 when the VSIF in the configuration file matches with the currently default system 160.

The switching module 106 notifies the MTA 16 to switch system when the VSIF in the configuration file mismatches with the currently default system 160. Then, the MTA 16 configures the backup system 162 to make the backup system 162 can boot after the cable modem 10 reboots. The switching module 106 configures the currently backup system 162 to be the default system and configures the currently default system 160 to be the backup system, and notifies the booting module 100 to boot with the newly configured default system, namely the original backup system 162.

For example, the default system 160 employs PC2.0 and the backup system 162 employs PC 1.0 or PC1.5. If the determination module 102 determines that the VSIF is configured as 1, the matching module 104 determines the default system 160 employing PC2.0 matches with the VSIF, and the cable modem 10 can complete the provisioning successfully with the default system 160 employing PC2.0.

In contrast, if the determination module 102 determines that the VSIF is configured as 2, the matching module 104 determines the default system 160 employing PC2.0 mismatches with the VSIF. Then, the switching module 106 switches the default system 160 and the backup system 162, namely configuring the original default system 160 employing PC2.0 to be the backup system and configure the original backup system 162 employing PC1.0 or PC1.5 to be the default system. As such, the booting module 100 reboots with the newly configured default system 160 which employs PC1.0 or PC1.5. Then, the matching module 104 determines the newly configured default system 160 employing PC1.0 or PC1.5 matches with the VSIF, and then the cable modem 10 can complete the provisioning successfully with the newly configured default system 160 employing PC1.0 or PC1.5.

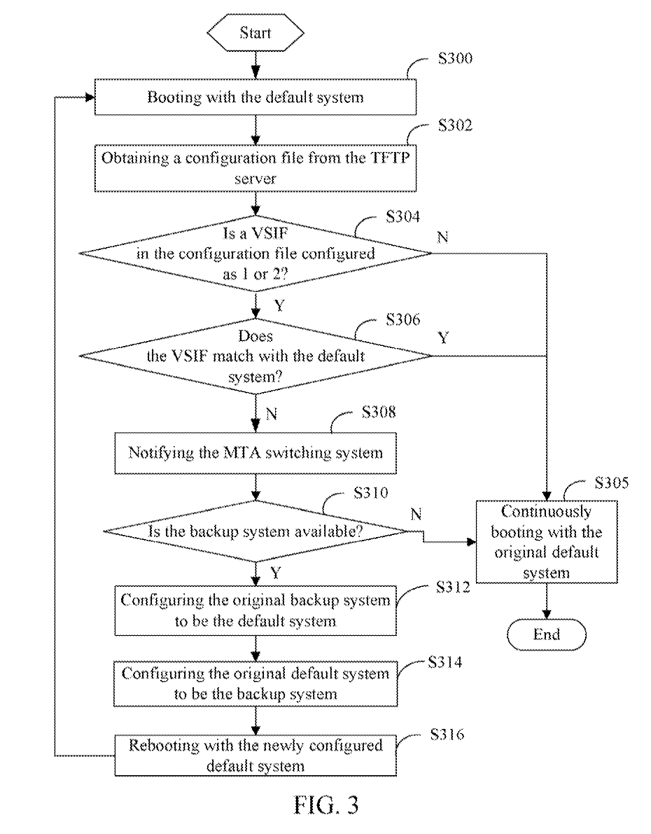

FIG. 3 is a flowchart of a method of supporting various PC protocol of one embodiment of the present disclosure. The flowchart is executed by the modules of FIG. 2. Depending on the embodiment, additional blocks may be added, others deleted, and the ordering of blocks may be changed while remaining well within the scope of the disclosure.

In block S300, the booting module 100 boots with the default system 160 in the MTA 16. In block S302, the determination module 102 obtains a configuration file from the TFTP server 40, and in block S304, determines if the service provider configures a vendor specific information (VSIF) in the configuration file as 1 or 2. If the VSIF in the configuration file is configured neither as 1 nor 2, then in block S305, the booting module 100 continuously boots with the default system 160 until the cable modem 10 completes the provisioning.

If the VSIF in the configuration file is configured as 12, then in block S306, the matching module 104 determines if the VSIF matches with the currently default system 160. If the VSIF in the configuration file matches with the currently default system 160, then in block S305, the booting module 100 continuously boots with the default system 160.

If the VSIF in the configuration file mismatches with the currently default system 160, then in block S308, the switching module 106 notifies the MTA 16 to switch system, and in block S310, determines if the backup system 162 is available. If the backup system 162 is unavailable, then in block S305, the booting module 100 continuously boots with the default system 160.

If the backup system 162 is available, then in block S312, the switching module 106 configures the currently backup system 162 to be the default system, and in block S314, configures the currently default system 160 to be the backup system. In block S316, the booting module 100 boots with the newly configured default system, namely the original backup system 162.

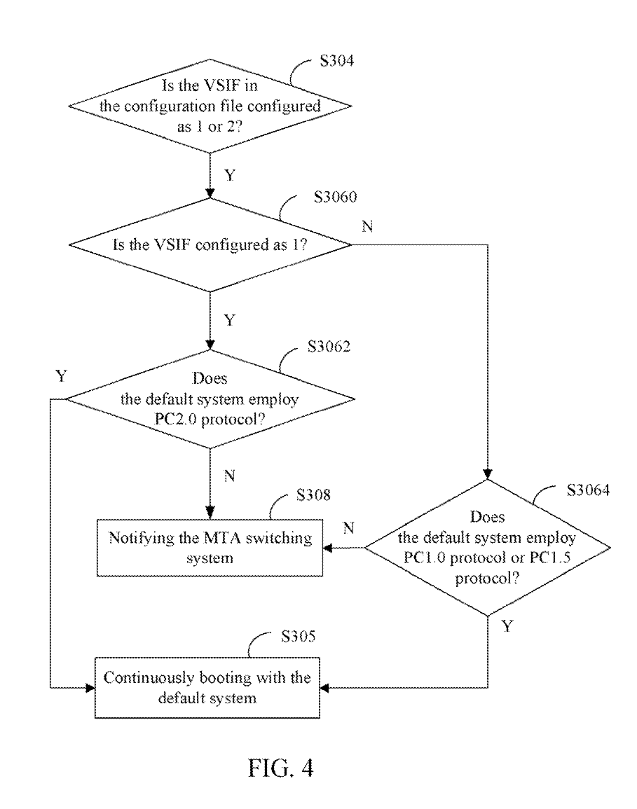

FIG. 4 is a detail flowchart of block S306 of determining if the VSIF in the configuration file is configured as 1 or 2 of the method shown in FIG. 3. In one embodiment, block S306 of FIG. 3 includes S3060 through S3064. Blocks S304, S305, and S308 are the same as that shown in FIG. 3

In block S3060, the matching module 104 determines if the VSIF is configured as 1. If the VSIF is configured as 1, then in block S3062, the matching module 104 determines if the currently default system 160 employs PC2.0. If the currently default system 160 employs PC2.0, the matching module 104 determines that the VSIF mismatches with the currently default system 160. As such, in block S308, the switching module 106 notifies the MTA 16 to switch system.

If the currently default system 160 does not employ PC2.0, the matching module 104 determines that the VSIF matches with the currently default system 160. Then in block S305, the booting module 100 continuously boots with the default system 160.

If the VSIF is not configured as 1, that is the VSIF is configured as 2, then in block S3064, the matching module 104 determines if the currently default system 160 employs PC1.0 or PC1.5. If the currently default system 160 employs PC1.0 or PC1.5, the matching module 104 determines that the VSIF matches with the currently default system 160. Then in block S305, the booting module 100 continuously boots with the default system 160.

If the currently default system 160 does not employ PC1.0 or PC1.5, the matching module 104 determines that the VSIF mismatches with the currently default system 160. As such, in block S308, the switching module 106 notifies the MTA 16 to switch system.

The cable modem 10 of the present disclosure automatically selects an available system from the default system 160 and the backup system 162 of the MTA 16 according to if the default system 160 of the cable modem 10 matches with the VSIF in the configuration file obtained from the TFTP server 40. Therefore, the cable modem 10 can support various PC protocol and can be wildly used in the VoIP network using the MGCP or the SIP.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A cable modem in communication with a trivial file transfer protocol (TFTP) server, the cable modem comprising:
a processor;
a multimedia terminal adapter (MTA) to provide voice over Internet protocol service, the MTA comprising a default system and a backup system employing a different packet cable protocol from that of the default system; and
a storage system, storing one or more programs operable to be executed by the processor, the one or more programs comprising:
a booting module to boot with the default system of the MTA;
a determination module to obtain a configuration file from the TFTP server, and to determine if a vendor specific information (VSIF) of the configuration file is configured as 1 or 2;
a matching module to determine if the VSIF matches with the default system upon the condition that the VSIF of the configuration file is configured as 1 or 2, and to continuously notify the booting module to boot with the default system upon the condition that the VSIF matches with the default system; and
a switching module to notify the MTA switching system, to configure the current default system to be the backup system and configure the currently backup system to be the default system, and to notify the booting module rebooting with the newly configured default system upon the condition that the VSIF mismatches with the default system.

2. The cable modem as claimed in claim 1, wherein the booting module continuously boots with the default system upon the condition that the VSIF of the configuration file is configured as neither 1 nor 2.

3. The cable modem as claimed in claim 1, wherein the matching module determines that the VSIF matches with the default system upon the condition that the VSIF is configured as 1 and the default system employs packet cable 2.0 protocol.

4. The cable modem as claimed in claim 1, wherein the matching module determines that the VSIF mismatches with the default system upon the condition that the VSIF is configured as 1 and the default system employs packet cable 1.0 protocol or packet cable 1.5 protocol.

5. The cable modem as claimed in claim 1, wherein the matching module determines that the VSIF mismatches with the default system upon the condition that the VSIF is configured as 2 and the default system employs packet cable 2.0 protocol.

6. The cable modem as claimed in claim 1, wherein the matching module determines that the VSIF matches with the default system upon the condition that the VSIF is configured as 2 and the default system employs packet cable 1.0 protocol or packet cable 1.5 protocol.

7. A method of supporting various packet cable protocols of a cable modem, the cable modem in communication with a trivial file transfer protocol (TFTP) server to support various packet cable protocols, the method comprising:
providing a default system and a backup system employing a different packet cable protocol from that of the default system for a multimedia terminal adapter (MTA) which provides voice over Internet protocol service of the cable modem;
booting with the default system of the MTA;
obtaining a configuration file from the TFTP server;
determining if a vendor specific information (VSIF) of the configuration file is configured as 1 or 2;
determining if the VSIF matches with the default system if the VSIF of the configuration file is configured as 1 or 2;
continuously booting with the default system if the VSIF matches with the default system; or
notifying the MTA switching system, configuring the currently default system to be the backup system and configuring the currently backup system to be the default system, and notifying the booting module rebooting with the newly configured default system if the VSIF mismatches with the default system.

8. The method as claimed in claim 7, further comprising: continuously booting with the default system if the VSIF of the configuration file is configured as neither 1 nor 2.

9. The method as claimed in claim 7, wherein determining if the VSIF matches with the default system comprises:
determining if the VSIF is configured as 1;
determining if the default system employs packet cable 2.0 protocol if the VSIF is configured as 1;
determining that the VSIF matches with the default system if the default system employs packet cable 2.0 protocol; or
determining that the VSIF mismatches with the default system if the default system does not employ packet cable 2.0 protocol.

10. The method as claimed in claim 9, wherein determining if the VSIF matches with the default system further comprises:
determining if the default system employs packet cable 1.0 protocol or packet cable 1.5 protocol if the VSIF is not configured as 1;
determining that the VSIF matches with the default system if the default system employs packet cable 1.0 protocol or packet cable 1.5 protocol; or
determining that the VSIF mismatches with the default system if the default system does not employ packet cable 1.0 protocol or packet cable 1.5 protocol.
